(19) United States
(12) Patent Application Publication
(10) Pub. No.: US 2024/0248524 A1
(43) Pub. Date: Jul. 25, 2024

(54) Power Management of a Power Regulator in a Processor During High Current Events

(71) Applicant: Groq, Inc., Mountain View, CA (US)

(72) Inventors: Santosh Raghavan, San Jose, CA (US); James David Sproch, Monte Sereno, CA (US); Vadim Heyfitch, Los Gatos, CA (US); Igor Arsovski, Williston, VT (US)

(21) Appl. No.: 18/525,055

(22) Filed: Nov. 30, 2023

Related U.S. Application Data
(60) Provisional application No. 63/440,910, filed on Jan. 24, 2023.
(60) Provisional application No. 63/502,567, filed on May 16, 2023.

(51) Int. Cl. G06F 1/3237; G06F 1/04

(52) U.S. Cl. CPC G06F 1/3237; G06F 1/04

(57) ABSTRACT

Methods are described for enabling clock waveform synthesis for, in one embodiment, tensor processors, that enable more efficient power management, shorter runtime latency, higher computational job throughput, and a lower implementation cost than alternative clock waveform methods. Further embodiments describe modifications to power regulators to enable programmatic control of power management. This Abstract and the independent Claims are concise signifiers of embodiments of the claimed inventions. The Abstract does not limit the scope of the claimed inventions.

### CROSS-REFERENCE TO RELATED APPLICATIONS

This application claims the benefit of priority to U.S. Provisional Application No. 63/440,910, filed Jan. 24, 2023, and entitled “POWER MANAGEMENT DURING HIGH CURRENT EVENTS.” This application also claims the benefit of priority to U.S. Provisional Application No. 63/502,567, filed May 16, 2023, and entitled “POWER MANAGEMENT OF POWER REGULATOR DURING HIGH CURRENT EVENTS.” The entirety of the above noted applications are expressly incorporated herein by reference.

### COPYRIGHT NOTICE

This patent document can be exactly reproduced as it appears in the files of the United States Patent and Trademark Office, but the assignee(s) otherwise reserves all rights in any subsets of included original works of authorship in this document protected by 17 USC 102(a) of the U.S. copyright law.

### SPECIFICATION—DISCLAIMERS

In the following Background, Summary, and Detailed Description, paragraph headings are signifiers that do not limit the scope of an embodiment of a claimed invention (ECIN). The citation or identification of any publication signifies neither relevance nor use as prior art. A paragraph for which the font is all italicized signifies text that exists in one or more patent specifications filed by the assignee(s).

A writing enclosed in double quotes (“ ”) signifies an exact copy of a writing that has been expressed as a work of authorship. Signifiers, such as a word or a phrase enclosed in single quotes (‘ ’), signify a term that as of yet has not been defined and that has no meaning to be evaluated for, or has no meaning in that specific use (for example, when the quoted term ‘module’ is first used) until defined.

### FIELD(S) OF TECHNOLOGY

This disclosure has general significance in the field of power management in processors, in particular, significance for the following topics: synthesizing clock waveforms for more efficient power management of power regulators for high-speed processors. This information is limited to use in the searching of the prior art.

### BACKGROUND

The operating frequency and waveform shape of a processor's system clock significantly impacts key performance metrics such as peak power, latency, throughput, energy required to perform a computation, and the rate of change of power supply load current. Common methods of manipulating the frequency of the clock generator, such as setting the clock frequency of a processor to one particular value during execution of an entire algorithm, may lack sufficient granularity or responsiveness to fully optimize system performance metrics.

Integrated circuits typically operate in several different modes such as high computational activity (during which power loads rise to excessive levels), low computational activity, and/or quiescent or sleep state. Overall system performance optimization requires different clock waveforms for each different mode, but dynamically changing the clock frequency has many limitations and incurs substantial implementation and operational costs. For example, clock frequency synthesis controllers often have coarse granularity and provide only a relatively small number of discrete operating frequencies. The switchover mechanism must guarantee waveform integrity during all clock phases, so switching to a different frequency may take several clock cycles. Changing the PLL (phase-locked loop) reference clock frequency or multiplier value produces indeterminate waveforms for many cycles as the PLL attempts to lock in on new reference conditions.

What others have failed to enable is a clock waveform generator that overcomes these limitations to improve the use of energy by a processor. Important to that improvement is the control of a power regulator to ensure that the proper power profile is timely delivered when power regulators are unable to respond due to rapid load driven requirements.

### SUMMARY

This Summary, together with any Claims, is a brief set of signifiers for at least one ECIN (which can be a discovery, see 35 USC 100(a); and see 35 USC 100(j)), for use in commerce for which the Specification and Drawings satisfy 35 USC 112.

In one or more ECINs disclosed herein, Programmatic Control of Processor Power Load (PCPPL) is enabled using clock period synthesis (CPS) methods and insertion of “No Operation” (NOP) instructions that enable more efficient power management, shorter runtime latency, higher computational job throughput, and a lower implementation cost than existing clock waveform methods for high-speed processors executing algorithms.

In some of the ECINs disclosed herein, a compiler enables PCPPL by inserting NOP instructions into the algorithm's instruction flow to lengthen the period of time for a power-intensive subset of the algorithm to be executed, which reduces the maximum power load.

In some of the ECINs disclosed herein, ‘dummy’ instructions are inserted by the compiler into the algorithm's instruction flow (such as doing mathematical operations which are not needed by the algorithm, but do require power), in order to minimize the difference in current loads during computationally intensive and computationally non-intensive subsets of the instruction flow of the algorithm.

In some of the ECINs disclosed herein, the PCPPL methods are specified by the user in a Service Level Agreement (SLA), for example, with the user specifying a clock period and waveform that minimizes power, or minimizes time of execution of the algorithm. In other embodiments, the PCPPL methods are automatically enabled by a compiler and the processor during execution when an upcoming power problem is anticipated (such as excessive di/dt).

In some of the ECINs disclosed herein, a method is disclosed for enabling Vdd (operating voltage of the processor) to be modified dynamically by software during the execution of a program. This method allows on-the-fly changes to Vdd where the change is deterministically initiated under processor software control, with safety limits and range scaling under supervisory control of a host processor (which executes the compiler), such as a RISC-V processor.

For background perspective, the primary core (non-IO) Vdd supply in a high-speed processor is typically be set to a particular operating point value before the processor is booted up, and if a change in Vdd is desired for different portions of a program, the program is partitioned into multiple segments, where between segments the program is halted, Vdd changed and stabilized, and finally the program is restarted, or for greater reliability, the processor is rebooted. The basic objective of improved Vdd dynamic control is to maximize performance in a given power envelope and to change voltage and frequency during runtime to mitigate di/dt events.

This Summary does not completely signify any ECIN. While this Summary can signify at least one essential element of an ECIN enabled by the Specification and Figures, the Summary does not signify any limitation in the scope of any ECIN.

### BRIEF DESCRIPTION OF THE DRAWINGS

The following Detailed Description, Figures, and Claims signify the uses of and progress enabled by one or more ECINs. All of the Figures are used only to provide knowledge and understanding and do not limit the scope of any ECIN. Such Figures are not necessarily drawn to scale.

FIG. 1 depicts a system for compiling a program to be executed on a specialized processor, in accordance with some embodiments.

FIGS. 2A and 2B illustrate instruction and data flow in a processor having a functional slice architecture, in accordance with some embodiments.

FIG. 3 depicts clock waveforms and their energy usage, in accordance with some embodiments.

FIG. 4 depicts an abstract floor plan for a processor with circuitry for clock period system, in accordance with some embodiments.

FIG. 5 depicts current loads for execution of an algorithm with subsets of instructions that computationally intensive and computationally non-intensive, in accordance with some embodiments.

FIG. 6 depicts an exemplary Deterministic (Dynamic) Voltage Scaling (DVS) block diagram, in accordance with some embodiments.

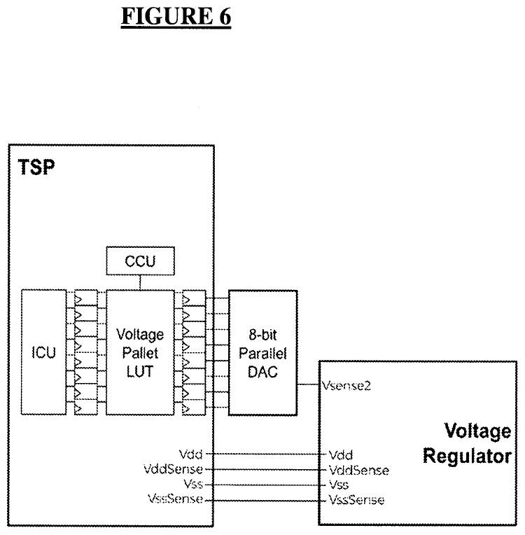

FIG. 7 depicts a computer system suitable for enabling embodiments of the claimed inventions.

The Figures can have the same, or similar, reference signifiers in the form of labels (such as alphanumeric symbols, e.g., reference numerals), and can signify a similar or equivalent function or use. Further, reference signifiers of the same type can be distinguished by appending to the reference label a dash and a second label that distinguishes among the similar signifiers. If only the first label is used in the Specification, its use applies to any similar component having the same label irrespective of any other reference labels. A brief list of the Figures is below.

In the Figures, reference signs can be omitted as is consistent with accepted engineering practice; however, a skilled person will understand that the illustrated components are understood in the context of the Figures as a whole, of the accompanying writings about such Figures, and of the embodiments of the claimed inventions.

### DETAILED DESCRIPTION

The Figures and Detailed Description, only to provide knowledge and understanding, signify at least one ECIN. To minimize the length of the Detailed Description, while various features, structures or characteristics can be described together in a single embodiment, they also can be used in other embodiments without being written about. Variations of any of these elements, and modules, processes, machines, systems, manufactures or compositions disclosed by such embodiments and/or examples are easily used in commerce. The Figures and Detailed Description signify, implicitly or explicitly, advantages and improvements of at least one ECIN for use in commerce.

In the Figures and Detailed Description, numerous specific details can be described to enable at least one ECIN. Any embodiment disclosed herein signifies a tangible form of a claimed invention. To not diminish the significance of the embodiments and/or examples in this Detailed Description, some elements that are known to a skilled person can be combined together for presentation and for illustration purposes and not be specified in detail. To not diminish the significance of these embodiments and/or examples, some well-known processes, machines, systems, manufactures or compositions are not written about in detail. However, a skilled person can use these embodiments and/or examples in commerce without these specific details or their equivalents. Thus, the Detailed Description focuses on enabling the inventive elements of any ECIN. Where this Detailed Description refers to some elements in the singular tense, more than one element can be depicted in the Figures and like elements are labeled with like numerals.

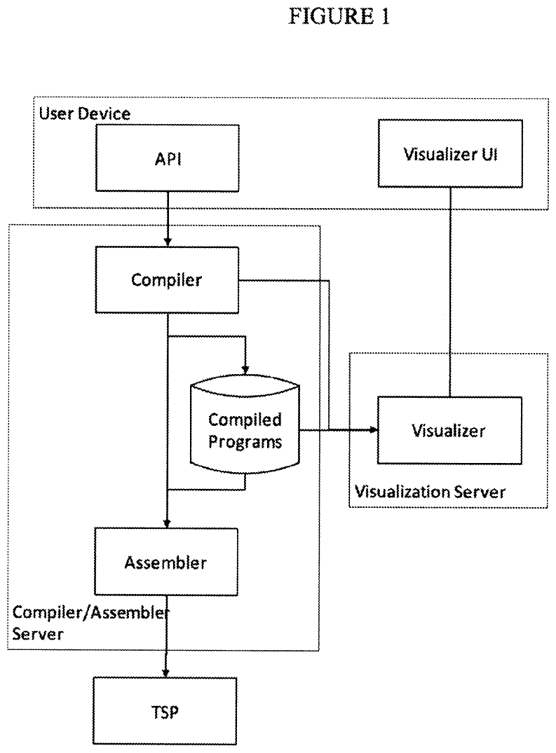

FIG. 1 illustrates a system 100 for compiling programs to be executed on a tensor processor, and for generating power usage information for the compiled programs, according to an embodiment. The system 100 includes a user device 102, a server 110, and a processor 120. Each of these components, and their sub-components (if any) are described in greater detail below. Although a particular configuration of components is described herein, in other embodiments the system 100 have different components and these components perform the functions of the system 100 in a different order or using a different mechanism. For example, while FIG. 1 illustrates a single server 110, in other embodiments, compilation, assembly, and power usage functions are performed on different devices. For example, in some embodiments, at least a portion of the functions performed by the server 110 are performed by the user device 102.

The user device 102 comprises any electronic computing device, such as a personal computer, laptop, or workstation, which uses an Application Program Interface (API) 104 to construct programs to be run on the processor 120. The server 110 receives a program specified by the user at the user device 102, and compiles the program to generate a compiled program 114. In some embodiments, a compiled program 114 enables a data model for predictions that processes input data and makes a prediction from the input data. Examples of predictions are category classifications made with a classifier, or predictions of time series values. In some embodiments, the prediction model describes a machine learning model that includes nodes, tensors, and weights. In one embodiment, the prediction model is specified as a TensorFlow model, the compiler 112 is a TensorFlow compiler and the processor 120 is a tensor processor. In another embodiment, the prediction model is specified as a PyTorch model, the compiler is a PyTorch compiler. In other embodiments, other machine learning specification languages and compilers are used. For example, in some embodiments, the prediction model defines nodes representing operators (e.g., arithmetic operators, matrix transformation operators, Boolean operators, etc.), tensors representing operands (e.g., values that the operators modify, such as scalar values, vector values, and matrix values, which may be represented in integer or floating-point format), and weight values that are generated and stored in the model after training. In some embodiments, where the processor 120 is a tensor processor having a functional slice architecture, the compiler 112 generates an explicit plan for how the processor will execute the program, by translating the program into a set of operations that are executed by the processor 120, specifying when each instruction will be executed, which functional slices will perform the work, and which stream registers will hold the operands. This type of scheduling is known as “deterministic scheduling”. This explicit plan for execution includes information for explicit prediction of excessive power usage by the processor when executing the program.

The assembler 116 receives compiled programs 114, generated by the compiler 112, and performs final compilation and linking of the scheduled instructions to generate a compiled binary. In some embodiments, the assembler 114 maps the scheduled instructions indicated in the compiled program 112 to the hardware of the server 110, and then determines the exact component queue in which to place each instruction.

The processor 120, e.g., is a hardware device with a massive number of matrix multiplier units that accepts a compiled binary assembled by the assembler 116, and executes the instructions included in the compiled binary. The processor 120 typically includes one or more blocks of circuitry for matrix arithmetic, numerical conversion, vector computation, short-term memory, and data permutation/switching. Once such processor 120 is a tensor processor having a functional slice architecture. In some embodiments, the processor 120 comprises multiple tensor processors connected together to execute a program.

### Example Processor

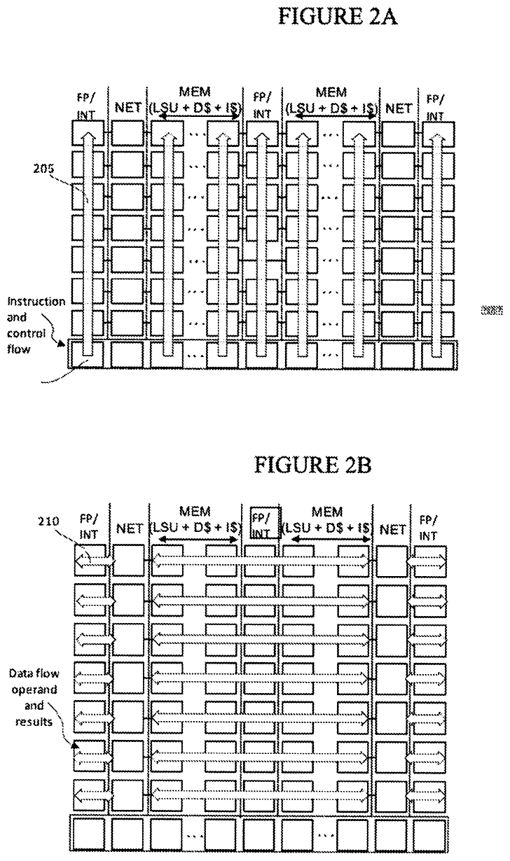

FIGS. 2A and 2B illustrate instruction and data flow in a processor having a functional slice architecture, in accordance with some embodiments. One enablement of processor 200 is as an application specific integrated circuit (ASIC), and corresponds to processor 120 such as illustrated in FIG. 1.

The functional units of processor 200 (also referred to as “functional tiles”) are aggregated into a plurality of functional process units (hereafter referred to as “slices”) 205, each corresponding to a particular function type in some embodiments. For example, different functional slices of the processor correspond to processing units for MEM (memory), VXM (vector execution module), MXM (matrix execution module), NIM (numerical interpretation module), and SXM (switching and permutation module). In other embodiments, each tile may include an aggregation of functional units such as a tile having both MEM and execution units by way of example. As illustrated in FIGS. 2A and 2B, each slice corresponds to a column of N functional units extending in a direction different (e.g, orthogonal) to the direction of the flow of data. The functional units of each slice can share an instruction queue (not shown) that stores instructions, and an instruction control unit (ICU) 210 that controls execution flow of the instructions. The instructions in a given instruction queue are executed only by functional units in the queue's associated slice and are not executed by another slice of the processor. In other embodiments, each functional unit has an associated ICU that controls the execution flow of the instructions.

Processor 200 also includes communication lanes to carry data between the functional units of different slices. Each communication lane connects to each of the slices 205 of processor 200. In some embodiments, a communication lane 220 that connects a row of functional units of adjacent slices is referred to as a “super-lane”, and comprises multiple data lanes, or “streams”, each configured to transport data values along a particular direction. For example, in some embodiments, each functional unit of processor 200 is connected to corresponding functional units on adjacent slices by a super-lane made up of multiple lanes. In other embodiments, processor 200 includes communication devices, such as a router, to carry data between adjacent functional units.

By arranging the functional units of processor 200 into different functional slices 205, the on-chip instruction and control flow of processor 200 is decoupled from the data flow. Since many types of data are acted upon by the same set of instructions, what is important for visualization is visualizing the flow of instructions, not the flow of data. For some embodiments, FIG. 2A illustrates the flow of instructions within the processor architecture, while FIG. 2B illustrates the flow of data within the processor architecture. As illustrated in FIGS. 2A and 2B, the instructions and control signals flow in a first direction across the functional units of processor 200 (e.g., along the length of the functional slices 205), while the data flows 220 flow in a second direction across the functional units of processor 200 (e.g., across the functional slices) that is non-parallel to the first direction, via the communication lanes (e.g., super-lanes) connecting the slices.

In some embodiments, the functional units in the same slice execute instructions in a ‘staggered’ fashion where instructions are issued tile-by-tile within the slice over a period of N cycles. For example, the ICU for a given slice may, during a first clock cycle, issues an instruction to a first tile of the slice (e.g., the bottom tile of the slice as illustrated in FIG. 2B, closest to the ICU of the slice), which is passed to subsequent functional units of the slice over subsequent cycles. That is, each row of functional units (corresponding to functional units along a particular super-lane) of processor 200 executes the same set of instructions, albeit offset in time, relative to the functional units of an adjacent row.

The functional slices of the processor are arranged such that operand data read from a memory slice is intercepted by different functional slices as the data moves across the chip, and results flow in the opposite direction where they are then written back to memory. For example, a first data flow from a first memory slice flows in a first direction (e.g., towards the right), where it is intercepted by a VXM slice that performs a vector operation on the received data. The data flow then continues to an MXM slice which performs a matrix operation on the received data. The processed data then flows in a second direction opposite from the first direction (e.g., towards the left), where it is again intercepted by VXM slice to perform an accumulate operation, and then written back to the memory slice.

In some embodiments, the functional slices of the processor are arranged such that data flow between memory and functional slices occur in both the first and second directions. For example, a second data flow originating from a second memory slice that travels in the second direction towards a second slice, where the data is intercepted and processed by VXM slice before traveling to the second MXM slice. The results of the matrix operation performed by the second MXM slice then flow in the first direction back towards the second memory slice.

In some embodiments, stream registers are located along a super-lane of the processor, in accordance with some embodiments. The stream registers are located between functional slices of the processor to facilitate the transport of data (e.g., operands and results) along each super-lane. For example, within the memory region of the processor, stream registers are located between sets of four MEM units. The stream registers are architecturally visible to the compiler, and serve as the primary hardware structure through which the compiler has visibility into the program's execution. Each functional unit of the set contains stream circuitry configured to allow the functional unit to read or write to the stream registers in either direction of the super-lane. In some embodiments, each stream register is implemented as a collection of registers, corresponding to each stream of the super-lane, and sized based upon the basic data type used by the processor (e.g., if the TSP's basic data type is an INT8, each register may be 8-bits wide). In some embodiments, in order to support larger operands (e.g., FP16 or INT32), multiple registers are collectively treated as one operand, where the operand is transmitted over multiple streams of the super-lane.

All of these functional features—superlanes of functional units, slices of instruction flow, handling of different types of integers and floating-point numbers, occurring trillions of times a second, create complicated power flows and possible disruptive power fluctuations that could negatively impact the performance of the processor. However, given the deterministic nature of executions by the processor, any disruptive power fluctuations (such as voltage droop) can be determined before execution of the program, with information (such as processor instructions, and timing for such instructions) about such fluctuations being supplied by the compiler to the processor, for the processor to use during program execution to mitigate the fluctuations.

### Dynamic Power Control of a Processor

In some of the ECINs disclosed here, clock period synthesis is used to achieve more efficient power management in a processor, especially tensor processors which perform billions and trillions of floating-point operations per second. When a large number of such operations are executed at the same time, or nearly at the same time, a can create potentially damaging electric current flows in the processor can occur, making it important to minimize changes in current flow (di/dt) during execution of a program.

In some of the ECINs disclosed herein, clock period synthesis is enabled by adding additional hardware and software instructions to a processor.

### Clock Waveform and Power Usage

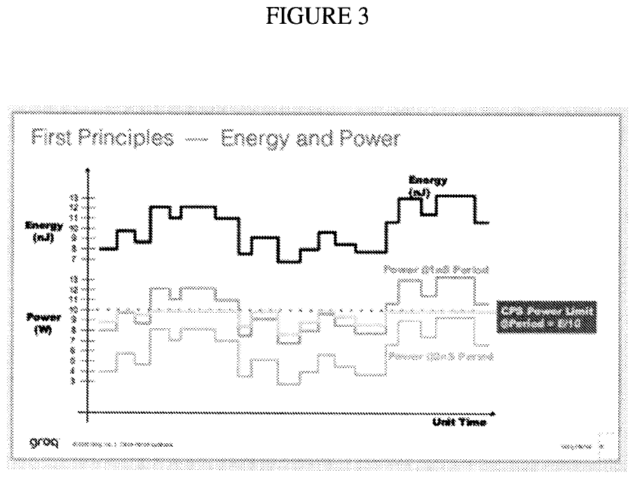

FIG. 3 depicts exemplary clock waveforms and power usage by the processor driven by the waveforms. Power consumption as it relates to a processor's clock waveform is roughly proportional to the capacitance (C) of all of the processor's switches times the square of the processors main voltage supply (Vdd) divided by the period (P) of the clock waveform (C*Vdd*Vdd/P). A processor, for example, using a 1 nanosecond clock period will consume twice as much power as a processor using a 2 nanosecond clock period, albeit performing the algorithm roughly half as fast.

### Clock Period Synthesis—Hardware

In some of the ECINS disclosed herein, the processor is required to have at least the following four elements: a High Frequency Clock (HFC) generated on an on-chip Phase Locked Loop (PLL) circuit where the period of the HFC is preferably shorter than the nominal period of the main clock (ChipClock) period; a waveform generator to produce the more useful ChipClock waveforms disclosed herein; a duration logic block to preload values for the waveform generator; and an instruction control unit (ICU) to provide instructions for the CPS methods disclosed herein.

ChipClock waveform resolution typically is half of the HFC period, representing the smallest increment of change for the ChipClock period. The duration of half of the HFC period is called the High Frequency Clock Phase Period (HFCPP).

As an example, an HFC period that is one-eighth the nominal ChipClock period enables an HFCPP that is 1/16th of the nominal ChipClock period. This HFCPP enables a clock period waveform resolution granularity of plus-or-minus 6.25%.

The nominal ChipClock period is an integer multiple of the HFCPP, but the multiple does not need to be a power of two (even though the math is to think about when the multiple is a power of two). The chip reset signal sets the ChipClock period to the Default ChipClock duration. The DefaultChipClock period can be overwritten by a CSR write. The CSR also has a MinClockPeriod field which is the minimum number of HFCPP periods allowed for ChipClock, and a EnableClockChange flag that prohibits any ChipClock period changes. The default value of the MinClockPeriod minimum ChipClock period register is equal to the hardware value of the DefaultChipClock period. The DefaultChipClock period should never be set to a value less than the MinClockPeriod. The default value of the EnableClockChange flag is FALSE to prohibit clock period changes until a CSR register write operation sets the value of the flag to TRUE. After the processor has booted (restarted) and a program is running, if the EnableClockChange flag is set to TRUE, ChipClock period changes are determined exclusively by subsequent software instructions, and a CSR write should not be used to change the period until after the user instructions have completed.

The minimum ChipClock period is four times the HFCPP, where the minimum ChipClock high time is twice HFCPP, and the minimum low time is twice HFCPP, forming a waveform with a 50/50 duty cycle. The minimum ChipClock period constraint implies that the HFC period should be less than or equal to one-half of the shortest ChipClock period that will be used. That is, the HFC frequency should be at least twice the frequency of the fastest ChipClock frequency that will be used.

The longest possible ChipClock period is limited by either the maximum size of the Target ChipClock Period field in the instruction format which is 3+2\hat{ }11=2,051, or by the number of shift register stages actually implemented in the CCU (Chip Control Unit), whichever is smaller. The instruction format and CCU shift register properties are described in respective sections below.

### Ramp Buster Capability

In some of the ECINS disclosed herein, processor current flow changes (di/dt) are managed by setting the Slope, Steep, and Linear fields in a CPS instruction word to values that increase or decrease the rate of change of the current drawn by the processor per unit time. This capability is used to control the rate of change in load current imposed on the voltage regulator during large step increases in load current, or during large release reductions in load current (when fewer instructions are being executed).

When Linear=0 and Steep=0, the ChipClock period is increased or decreased by another unit of HFCPP after each time Slope ChipClock periods have been completed, until the ChipClock period equals the TargetPeriod. A larger Slope value will cause the di/dt value to be smaller. When Steep=0, Risc=1, and Run=Slope, for Ramp=Risc/Run.

When Linear=0 and Steep=1, the ChipClock period is increased or decreased by Slope units of HFCPP after each ChipClock period has been completed, until the ChipClock period equals the TargetPeriod. A larger Slope value will cause the di/dt value to be larger. When Steep=1, Risc=Slope, and Run=1, for Ramp=Risc/Run.

When Linear=1 and Steep=0, the ChipClock period is increased or decreased by another unit of HFCPP after each time (Slope+Extra) ChipClock periods have been completed, until the ChipClock period equals the TargetPeriod. The number of Extra ChipClock periods is determined by the Duration Logic block based on the number of HFCPP periods in the current ChipClock period. When the ChipClock period is a small number of HFCPP periods, many Extra ChipClock periods are added between changes in the value of the ChipClock period to linearize the di/dt with respect to the duration of the ChipClock period.

When Linear=1 and Steep=1, the ChipClock period is increased or decreased by (Slope−Extra) units of HFCPP after each ChipClock period has been completed, until the ChipClock period equals the TargetPeriod. The number of Extra HFCPP units to be subtracted is determined by the Duration Logic block based on the number of HFCPP periods in the current ChipClock period. When the ChipClock period is a small number of HFCPP periods, many Extra HFCPP units are subtracted between changes in the value of the ChipClock period to linearize the di/dt with respect to the duration of the ChipClock period.

### Instructions for Runtime Acceleration

With adequate timing information describing different timing support for different subsets of instructions, the compiler can identify certain instruction subsets or segments of instructions that may operate at a shorter clock period than other instruction subsets or segments. As used herein, both subsets and segments refer to a sequence of instructions. A program may comprises many such instruction subsets or segments of instructions.

To exploit this opportunity, the hardware design process for the processor needs to include additional timing closure activities. For example, the entire processor chip may close timing at say 1.1 GHZ, and certain circuitry subsets of the chip may close timing at 1.2 GHZ. Attention should be exercised when closing timing on a circuitry subset of the chip, and in particular, that metastability-triggering situations should be exhaustively precluded.

As an example of how this is managed, recall that the exemplary processor may have, for example, 144 separate Instruction Control Units, each independently serving a functional slice, and that data pathways that are not being used have clock gating applied. After profiling the instruction mix emitted by the compiler, a commonly occurring subset or segments of instructions is identified that are not in the blocks with the most difficult critical paths. An operational mode can be configured to run STA, where for example no vector-matrix multiply (VXM) instruction is dispatched, and no memory write operations are underway. If timing is closed with a shorter clock period in this mode, then CPS can use a shorter clock period whenever no instructions are underway outside of this subset.

### Clock Period Synthesis Circuit Description

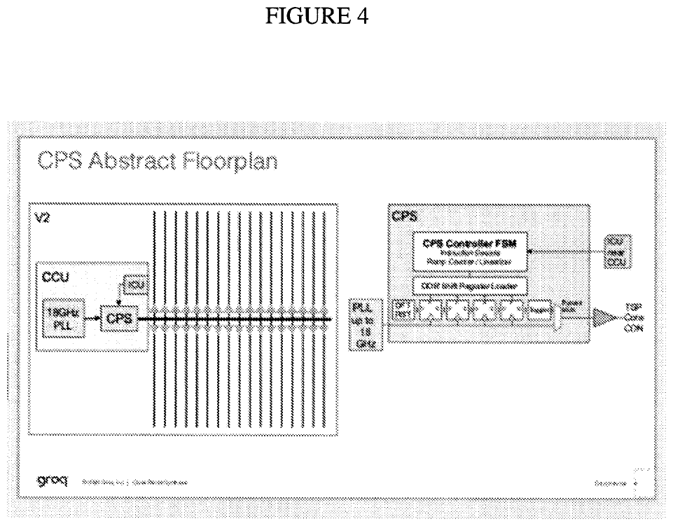

A relatively small number of logic gates are required for CPS. FIG. 4 depicts an exemplary CPS circuit that that is physically implemented in Chip Control Unit (CCU), as part of the PLL/Clock Control Module, and the CPS ICU piggybacks off of the nearest, most appropriate ICU block. For example, for the TSP tensor processor available from Groq, given that the main vertical clock spine is located at the Prime Meridian of the chip, the preferred location of the CCU is as close as possible to the Prime Meridian at the bottom center of the chip. This location makes it desirable to locate the CPS ICU near the ICU blocks that serve VXM slices near the center of the chip.

Also depicted in FIG. 4 is a toggle flip-flop structure used by the CPS, with programmable delays to determine the high-time and low-time of ChipClock. Programmable delays are implemented as shift registers that are clocked by a high frequency clock that operates at, for example, eight times the nominal chip clock frequency. The duration of each phase of each clock cycle is determined by “next state” values loaded into the high state and low state shift registers, respectively. Next state logic preloads the shift registers with new period values on respective ChipClock edges. For a given resolution, the dynamic power of the shift registers can be cut in half by using rising and falling edges to implement half-cycle resolution, where the precision of this operation depends on the degree of symmetry in the duty cycle of the high frequency reference clock.

The period of the high frequency clock and the number of shift register stages required for CPS are together determined by the nominal ChipClock period, the desired waveform granularity, and the maximum desired clock period for low power operating modes. For example, with a nominal 1 nS ChipClock period, 6.25% waveform granularity, and a maximum ChipClock period that is 16 times the nominal ChipClock period, the number of shift register stages required would be as follows.

The duration of HFCPP is the ChipClock period times the waveform granularity percentage, for example, 1 nS*6.25%=0.0625 nS (nanoseconds). The period of the HFC is two times the duration of HFCPP, which here equals 2*0.0625 nS=0.125 nS, so the HFC would be 8 GHz. The number of shift register stages required is the maximum ChipClock period divided by the HFC period, or 16 nS/0.125 nS=128 DFF stages, plus a few extra DFFs to implement one HFCPP resolution. In one embodiment, the shift register stages are allocated half to one period, the HighTime, and half to a second period, the LowTime.

### Clock Period Synthesis—Software Requirements

### Clock Period Synthesis Instructions

CPS instructions are intentionally orthogonal to other functional instructions. CPS instructions can dispatch as often as once per ChipClock. In the absence of any CPS instructions for a job, the ChipClock period defaults to a default value at boot time. A CSR register write can be used to overwrite the HW default ChipClock period. Chip Reset sets the ChipClock period to the default value. Cumulative clock periods are aligned at data transfer times, which should be considered invariant during instruction scheduling by the compiler. The compiler should keep a tally of the real-time duration of the instructions executed on each chip in a multi-processor system. The real-time values should be deterministically aligned at data transfer times. The compiler has a great deal of flexibility to optimize clock durations on each individual processor, although the longest duration required during each synchronization interval will dominate.

Note that an alternative compiler instruction scheduling approach is also possible, whereby system-level flexibility is extended by using information from the Board Management Controller (BMC) to enable a multichip synchronization strategy that is adaptive to heterogeneous operating points that may change independently over time.

Software control of ChipClock periods is achieved by configuring four CPS instruction parameter values: TargetPeriod, Slope, Steep, and Linear. All four parameters are set in each instruction. The TargetPeriod specifies the number of HFCPP periods that will be in each ChipClock period, where the high time and low time are balanced as much as possible by the hardware algorithms. A separate instruction is used to configure the Duration module to operate with an asymmetric duty cycle for circuits such as memory arrays that require an asymmetric duty cycle for optimized operation.

To control processor current flows, di/dt, it is desirable to spread out instantaneous changes in the magnitude of current drawn by the processor. The Slope, Steep, and Linear parameters specify the size of the incremental steps taken during each ChipClock period change while transitioning from the current value of ChipClock to the TargetPeriod.

CPS Instruction Word Format

| Pos | Field | Description |
|---|---|---|
| 23:13 | TargetPeriod | ChipClock will transition to TargetPeriod according |
| | | to the Slope, Steep, and Linear options below; If |
| | | (TargetPeriod < 4) TargetPeriod += 2\hat{ }11 |
| 12 | Linear | If (Linear = 1) then the Slope is linearized |
| 11 | Steep | If (Steep = 1) then Slope is the number of HFCPP |
| | | units add/subtracted during each ChipClock period; |
| | | If (Steep = 0) then ChipClock period is changed |
| | | by one HFCPP unit after Slope ChipClock periods |
| 10:0 | Slope | ClockPeriod rate of change toward TargetPeriod; If |
| | | (Slope = 0) ClockPeriod = TargetPeriod |
| | | immediately |

The proposed CPS instruction word format given uses up to 11 bits for the TargetPeriod field which also provides for future expansion.

New CPS Instructions immediately preempt previously dispatched instructions, even if the ChipClock period is not yet equal to the TargetPeriod specified in the previous instruction (e.g., the ChipClock period is still changing). Extra care is advised when the Compiler calculates the timing consequences of a preempted CPS instruction.

The Linear field linearizes di/dt as the ChipClock period increases or decreases for small values of the ChipClock period. Without linearization, di/dt would be much larger for each change in ChipClock period for smaller ChipClock period durations. The pattern is a concave curve that has the functional shape of 1/x. By reducing the di/dt for smaller ChipClock periods, the di/dt is linearized, as shown in the Linearization Plot and the Linearization Table below.

Linearization is activated when (Linear==1 AND Steep==0 AND Slope>0), causing the CPS FSM to emit a preselected sequence of N period values from a stored table, each period value is repeated Slope times, thus defining the next N*Slope clock periods. N is a function of the distance (in ticks) between the current clock period and the target clock period, where N=34 when the destination clock period is at 4 ticks, 26 @ 5, 21 @ 6, 17 @ 7, 15 @ 8, 13@ 9, 12@ 10, 11@ 11, 10@ 12, 9@ 13, 8@ 14-15, 7@ 15, 6@ 16, 5@ 17, 4@ 18, 3@ 19, and 2 @ 20.

### Operating Point Voltage and Frequency

The ability to set safe and reliable operating conditions is essential for electrical systems. In processor systems available from Groq, the main operating Vdd voltage for the processor can be changed via the Board Management Controller (BMC) using a PCB microcontroller that interfaced with the voltage regulators through Serial Peripheral Interface (SPI) bus ports, and similarly the PCB clock generator frequency can be set to provide an appropriate reference clock frequency for the on-chip PLL. Changes to Vdd or the Reference Clock Frequency are made between jobs. Changing the external Reference Clock Frequency while the processor is operating is not advised because invalid clock periods may result as the PLL tracks to lock-in on the new reference clock frequency. In the best case, if the processor continued to operate, the latency would be indeterminate because PLL tracking has significant uncertainty, and the power would also be less predictable due to the changing clock frequency. Power levels would also be uncertain during the time it takes a Vdd level change to propagate through the voltage regulator to slew the output voltage to the new setpoint.

### Deterministic-Dynamic Voltage Control

In some of the embodiments disclosed herein, software instructions are used to change the Vdd operating voltage of the processor while a program is running. For example, a new CCU instruction is defined that sends information out via one or more serial or parallel pins to be intercepted by the BMC microcontroller. The microcontroller then reconfigures the Vdd voltage level by changing the regulator using the SPI bus or other appropriate interface mechanisms depending on the PCB hardware. The microcontroller then monitors the changing Vdd level, and when it is confirmed to be stabilized at the new level, the BMC sends an acknowledgement back to the processor. Clock period reductions or PLL clock frequency increases that require the new Vdd voltage need to ensure that the new voltage has stabilized either by monitoring the acknowledgement signal, or by waiting for some statutory time that is enforced as a constraint on the design of the BMC and voltage regulator latency. To reduce the chance of damage to a system, it may be necessary to prevent user programs from setting a new Vdd voltage by enforcing a privileged supervisory mode where only an authenticated and trusted compiler enables the encrypted/protected instructions.

Changes to the Vdd processor operating voltage normally are made only between jobs to avoid reliability problems. The safest approach is to only change the Vdd voltage while the processor is in a reset state. An intermediate level of risk is to use Sync instructions to stop instruction activity in the chip, and to also slow down the clock as much as possible while changing Vdd.

A possible core instruction sequence is to issue a Sync command, then issue an external interrupt to the host via IO ICU, using the external interrupt to get the attention of the host. The interrupt has a specific interrupt ID to inform the handler of the purpose of the interrupt. After the handler has enabled the voltage change, it would set a CSR to notify the processor, constituting an ACK back to the running program. Changes are expected to occur between program runs, and in particular the voltage and frequency can be changed to minimize power consumption during the quiescent time between jobs.

Note: when the processor core is not executing user instructions, the clock continues to operate, which wastes dynamic power. Under these conditions, it is desirable to set the ChipClock to a very long period to reduce the power waste. This mode of operation is fully supported by CPS and requires no additional hardware support.

### Qualitative Comparison Between CPS and NOP Insertion

The NOP insertion method is known to have certain qualitative strengths and weaknesses. Specifically, NOPs are already available in the ISA model of the Groq processor as well as most other processor architectures. Further, NOP insertion is compatible with DVFS—set your operating voltage and clock frequency, and all program instructions, including NOPs, execute at that operating point. However, increased SW code complexity is required in order to weave NOPs into linear code or loops within a particular functional unit on one processor chip. This increased SW code complexity is compounded when attempting to coordinate and align NOP insertion between functional units or across multiple chips in a topology.

In addition to the complexity of deciding where to insert NOPs, the volume of memory required to store NOP instructions adds considerably to the consumption of SRAM. NOP insertion also has coarse granularity with zero, one, or N NOPs inserted at any particular location in the program. Further still, NOPs are instruction cycles that use energy (vs CPS which does not add any energy-consuming clock network transitions).

The CPS insertion method is known to have certain qualitative strengths.

Specifically, the compiler complexity is divided into two relatively tasks: first compile the fastest, densest program possible (ignoring power considerations); then in a simple second phase the code is post-processed to set the clock period to manage power using an independent ICU code stream. The compiler only needs to align real-time anchor points periodically between chips connected in a multi-chip topology allowing individual instruction cycles to be independently configured. The independent CPS instruction stream can be implemented very efficiently such as by setting a different clock period for each of the 50 ResNet50 layers, or with the precision of a different clock period for individual instruction cycles when necessary and pre-programmed di/dt ramp operations dramatically reduce the need for instruction storage space.

Because CPS granularity is at the sub-cycle level, it can be programmatically adjusted with the tradeoff of finer granularity using a faster high-frequency PLL clock frequency. CPS allows the period of each individual clock cycle to be tuned to maximize compute performance, minimize overall energy usage, and operate consistently and precisely within the provisioned power and thermal envelopes. CPS is compatible with DVFS—set a baseline operating voltage and clock frequency, and program instructions, with or without NOPs, execute at the shortest possible period for that instruction cycle (which may be shorter than the worst-case timing closure period), and at all times stay within the bounds of the provisioned power, di/dt, and thermal envelope.

### Programmatic Control of Processor Power Load

One use of both CPS with NOPs is to control processor power load for an algorithm, when it can be determined by the compiler before program execution that some subset of the algorithm's instructions, when executed, will require power loads that exceed operational limits of the processor or an array of processors.

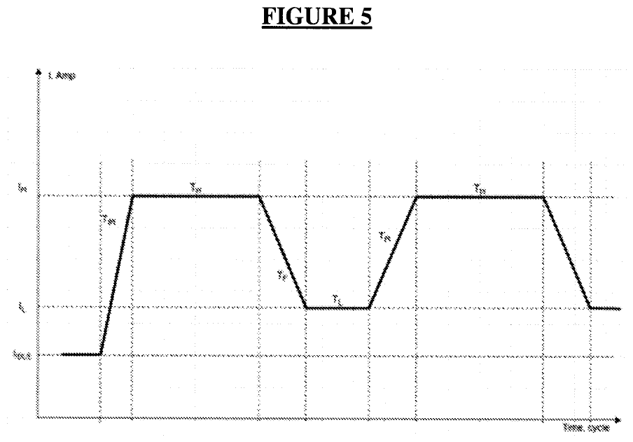

FIG. 5 depicts current loads for execution of an algorithm with subsets of instructions that are computationally intensive (T_{H}) and computationally non-intensive (T_{L}). Given the high current (I_{H}) flows during the computationally intensive subsets and the effective resistance of the processor (R_{P}), in some cases the power load (I_{H}² R_{P}) will exceed operational limits of the processor (or of an array of processors), where current loads can be in the thousands of amps for a processor array that has an effective impedance of a tenth of ohm (the power used then being in the hundreds of kilowatts).

FIG. 5 depicts a current load initial ramp up at the beginning of a program execution, then the first high-load cycle, then a ramp-down, followed by the lull and a ramp-up of the next in-program high-load cycle. In some of the embodiments disclosed herein, PCPPL is used to reduce the power consumed during the high-load cycles.

In some of the embodiments disclosed herein, No Operation (NOP) instructions are added (also referred to by ‘padded’) by the compiler to the algorithm's instructions to lengthen the amount of time need to execute a computationally intensive subset of an algorithm. Since NOP instructions use very little current, using NOPs reduces the average and maximum current loads by spacing out in time the instructions that use high amounts of current.

In some of the embodiments disclosed herein, the ramp up times from processor idle to processor algorithm execution, and from processor load activity execution (T_{L}) to processor high activity execution (T_{H}), are increased by having the compiler stretch out in time the execution of instructions during the ramp time. This enables additional control of di/dt.

In some embodiments of the ECINs disclosed herein, ‘dummy’ instructions are inserted by the compiler into the algorithm's instruction flow (such as doing mathematical operations the results of which are not later used), to minimize the difference in current loads during computationally intensive and computationally non-intensive subsets of the algorithm's instruction flow. While this increases the average power used by the algorithm during its execution, it minimizes power swings and heat flows across the processor so that the processor's cooling systems can more efficiently maintain the processor within operational temperature limits. The increase in average power will not be significant if the length of time of T_{H} is significantly greater than the length of time of T_{L}.

In some embodiments of the ECINs disclosed herein, the Clock Period Synthesis methods described above can be used to, with or without the use of NOP insertion, to reduce the average and maximum current loads by spacing out in time the instructions that use high amounts of current during the T_{H} time periods. Temporarily reducing the clock frequency during T_{H} time periods reduces instantaneous power use (see FIG. 3), while allowing more time for heat dissipation. When a user of processor needs to perform a computationally intensive algorithm, no matter what the power flow requirements imposed upon by the processor (which typically have a cost specified in the Service Level Agreement), the use of Clock Period Synthesis allows the user's need to be fulfilled without physically damaging the processor.

In some embodiments of the ECINs disclosed herein, the Deterministic (Dynamic) Voltage Scaling (DVS) method provides a low-latency hardware solution for a Vdd Voltage Regulator (VR) sense input under direct TSP software control, with boundary limits and scaling under supervisory control by the CCU RISC-V processor.

The architecture of the Deterministic (Dynamic) Voltage Scaling method comprises these seven elements:

### 1. Deterministic TSP Software Control

A new DVS instruction is added to the ICU that serves CPS, located near or adjacent to the CCU module. The new instruction has an eight-bit field that specifies a new target Vdd value, which then remains in effect until a subsequent DVS instruction is dispatched. The Vdd value is initialized to a default value at powerup as part of the processor boot sequence.

$$\\ Instruction Format : Bits [ 15 : 8 ] = Target Vdd Value ;$$

$$\\ Bits [ 7 : 0 ] = Reserved zero bits and Op Code ( e . g . 0 \times 3 )$$

### 2. Boundary Limits and Scaling

The new Target Vdd value is set when a DVS instruction is dispatched and the value is stored in an eight-bit register in the CCU. The Target Vdd value drives the address input pins of a 256-byte SRAM Lookup Table (LUT) used as the “Voltage Pallet”. The eight-bit output of the Voltage Pallet SRAM is clocked into a register as the Digital Vdd value which directly drives a set of eight GPIO pins. The Voltage Pallet is initialized by the CCU RISC-V processor via an AHB interface, and/or via CSR control. The values populated in the SRAM allow any input value or range of values to be mapped to a saturation value for safe operation (to enforce upper and lower bounds), and/or in-range values can be scaled or offset to provide a runtime transformation of the compiled values. For example, the SRAM contents may implement a scaling function to normalize the operation of TSP devices from different process corners.

### 3. External PCB Hardware

The set of eight GPIO pins that drive the Digital Vdd value out of the high-speed processor are connected to an eight-bit, parallel input Digital to Analog Controller (DAC) chip. The DAC output is either a voltage or, more often, a current that is passed through a precision resistor to ground to produce the desired output voltage. In either case, the voltage is passed through a low-pass filter, and applied to the second voltage sense input of the VR, where the first voltage sense input is the traditional sense line connected to the Vdd sense terminal on the target device package itself.

An alternative VR connection method, where there may not be a second Vsense input, is to directly drive the PWM VID input on the VR with a GPIO pin configured to emit the PWM VID protocol signal. Another option is to use the DAC analog output if the VR uses the PWM VID input as an analog signal.

The expectation is that, whichever input is used, the VR's internal (possibly DSP-based) parameterized PID control algorithm incorporates the values provided on the Vsense2 or PWM VID input in conjunction with the traditional Vsense feedback input to be incorporated in the feedback loop to control the output voltage supplied to the load device.

Using the second input path on the VRM (e.g. Vsense2) to receive the precompensation signal provided from the processor has significant advantages including:

1. The primary Vsense signal path is a simple, direct wire.

2. The primary Vsense signal path does not introduce any additional delay, voltage offset, waveform distortion, or noise that would be caused by the insertion of an op amp or voltage summation circuit in the primary feedback path.

3. The primary Vsense signal can be algorithmically combined with the Vsense2 pre-compensation signal internally to the VRM as part of the PID algorithm for precise control of the dynamic voltage output.

### 4. Example DAC Chips.

There are many alternative eight-bit DAC chips that can used on the PCB to transform the Digital Vdd value to an analog voltage. Slower, lower cost DAC devices may be available at a significantly lower price point. Here are some example high-speed devices (circa 2023): ADC9748 which is a DAC 8-bit, low power, parallel interface with 210 MS/s, 11 nS settling time; or MAX5852 which is a DAC 8-bit, 2-channel, parallel interface, 200 MS/s, 12 nS settling time. An alternative is to integrate the DAC onto the processor die. This has advantages such as fewer PCB components in the BOM, and avoiding the need for seven of the eight GPIO pins. Disadvantages of an integrated DAC include the necessity to route the analog voltage out of the processor and across the PCB to get to the LPF and then the VR Vsense2 input pin, as well as the cost and design complexity of incorporating an analog DAC IP module.

### 5. Example Voltage Regulators:

Infincon-TLD5541 high power Buck-Boost controller is a good example of a VR controller that includes a primary VFB voltage feedback sense input that can track Vdd at a ball grid pin of the load device, and also includes a pair of FBH/FBL pins as a second input to the PID control loop. The DAC output, for example, is connected to the FBH/FBL pins.

Example regulators include but are not limited to the XDPE1A2G5A Digital Multi-phase Controller 16-phase Dual Loop Voltage Regulator, the XDPE1A2G7A Digital Multi-phase Controller 16-phase Dual Loop Voltage Regulator or the XDPE1A2G5B Digital Multi-phase Controller 16-phase Dual Loop Voltage Regulator.

The XDPELA2G5 controller provides the capability to estimate the input power consumption of the individual voltage regulator. The input power supply voltage is monitored via an input, VINSEN, for feedforward control, telemetry, power sequencing, and fault detection.

Note that differential output voltage sense (VOSEN_Lx/VORTN_Lx) are differentially senses the remote output voltage of each rail and may be used for PID loop compensation, over voltage fault protection, and telemetry. The output voltages of all rails are sensed differentially and converted to a digital representation over a range of 0 to 3.1 V using a high speed, precision analog-to-digital converter. An on-processor factory trimmed temperature compensated bandgap voltage reference ensures precise set-point accuracy.

### 6. Latency

The time required from the DVS instruction dispatch to the GPIO output pins driven to the new Digital Vdd value is two clock periods plus the propagation time of the GPIO pins. After an additional small wire delay on the PCB for these signals to get to the DAC, and the settling time of the DAC, and the delay of the low-pass filter, the updated Vsense2 value will be available to the VR chip. The latency from the new reference Vdd value until the adjusted output voltage is available and stabilized at the transistors on the processor load device is a function of the VR controller and power stage. For some VR configurations, this delay may be several microseconds or even tens of microseconds. System and VR latency information must be known by the compiler at compile time to take advantage of DVS for changes that take effect dynamically during the execution of an algorithm. In an alternative embodiment, the compiler may iteratively adjust the latency using the technique described in commonly owned U.S. patent Ser. No. 10/516,383, which issued Dec. 24, 2019 entitled Reducing Power Consumption in a Processor Circuit.

### 7. Pre-Emphasis.

One possible application of DVS exploiting the low-latency, deterministic signal path linking the processor instruction sequence to a voltage regulator input involves the use of pre-emphasis (e.g., pre-compensation) to mitigate certain undesirable effects in the VR algorithm. Without pre-emphasis, the VR responds to a steep change in load current only after a delay of several microseconds. When the load current increases quickly, the Vdd voltage at the transistors on the chip drops down (or droops) due to L*di/dt reactive properties of the Power Distribution Network and also because the VR response lags (is delayed) with respect to the voltage sense signal which communicates the drop in Vdd to the VR. When the load current decreases quickly, the Vdd voltage may spike up, possibly overshooting high enough to exceed the absolute maximum operating voltage for devices implemented using a particular fabrication technology. Pre-emphasis provides advance information to the voltage regulator of an imminent change in load current. The latency of the VR can be compensated for by scheduling the pre-emphasis signal to be sent earlier. Any non-deterministic aspects in the VR response, such as clock domain crossings or loops in the DSP control algorithm, may present challenges or limitations on the application of pre-emphasis. If the VR response is faster than the nominal expectation, the pre-emphasis can itself cause Vdd to over- or under-shoot, and if the VR response is slower than the nominal expectation, the natural Vdd droop or overshoot can still occur anyway, and then be followed immediately by a Vdd shift in the opposite direction.

### Preemptive Voltage Regulator Control Invention

For relative voltage control (as opposed to absolute voltage) with respect to the target Vdd or relative to instantaneous actual Vdd, the preemptive input signal must include a way to influence the voltage regulator output proportional to the magnitude of the di/dt event.

A good technique is to use an available second sense input with a delta voltage that communicates the magnitude of desired response. Where a second sense input is unavailable, the DVID input may serve the same purpose using a different mechanism, where the target output voltage is changed in proportion to the di/dt mitigation required.

Another alternative is using a multiplying DAC, using the target or preferably the instantaneous Vdd as the DAC reference (after LPF), where the center point is at Vdd and the range is from zero to 2×Vdd, and a bipolar buffer amplifier would provide a very low impedance drive to be summed with the low impedance sense Vdd sense feedback signal.

Another alternative is to use switched capacitors to couple the preemptive voltage sense perturbation. A processor or FPGA output signal would transition from Vss to Vdd for a positive pulse, or from Vdd to Vss for a negative pulse, driving one side of a capacitor where the other side of the capacitor is the Vsense input pin of the VRM. The up/down events could be done in pairs which is easy to implement but parasitic resistances may be problematic. Another simple method is to put a self-discharging resistor across the capacitor, where the resistor has a high enough resistance to not significantly perturb the sense line, and a small enough resistance to discharge the capacitor in time for the next event; again if the up/down operations are done in pairs it may be possible to get away with no isolation switch. Another method is to use an isolation switch and either a passive shunt resistor or an active shunt FET.

Request timing (latency and variance, FPGA clock is at best ½ or ¼ of TSP frequency, takes attention to track, additional delay and variance in output path), delay through the DAC and LPF and Received timing, for example, +/−one Switch Mode Power Supply (SMPS) clock period; this could be influenced by possibly making our request aware of the SMPS clock or by us explicitly determining the phase edges of the SMPS clock.

Synchronization of a request to the SMPS clock is another possibility, using CPS within the processor or using a CPS like mechanism to vary the phase relationship of the SMPS clock. Easier to stay aligned if the SMPS and processor share a common reference clock signal, perform alignment once at boot time.

Reaction timing (+/−additional SMPS clock periods); uses information from VRM vendors to determine exactly how many SMPS clock periods are required to influence Vdd sufficiently for a multiphase controller. For VRMs that have an internal PLL to generate an internal clock that is a higher frequency than the external SMPS reference clock, the reaction timing will depend on the which cycle the DSP detects the input voltage change; this adds another source of variance which is +/−one of these internal clock periods. For VRMs that have a fixed deterministic relationship to the rising or falling edge of the external clock as a known property of the design or from empirical measurements, the reaction timing can be compensated using a mechanism like that used for the request timing mitigation. For VRMs that have an arbitrary relationship between the internal clock and the external reference clock, the response time needs to be measured and reported to the TSP each time the system is booted up.

Synchronize the TSP data transfer to the SMPS clock, or a specific offset from the SMPS clock edge where the sampling occurs. This sampling may be done using an internally generated clock higher frequency clock. The offset can be determined by knowledge of the design, or determined empirically by measuring the latency.

Realization waveform. With an internal modification of the DSP PID algorithm, the TSP sends a digital signal to select a stored pattern of deviation over time, essentially a PWL or point-by-point adjustment, plus or minus whatever the Vdd sense feedback processed through the PID algorithm foundation provides.

One embodiment is a set of direct inputs, driven by the deterministic TSP or companion FPGA, that activate a pre-compensation event, with parameter bits to select the polarity, magnitude, and duration of the pre-compensation effect. The shape of the mitigation waveform can be stored in an internal memory region in the VRM.

Example of using the VID input with the Intel protocol as the second input to adjust the voltage output for Vdd. See in particular page 11 which shows the VFB input as a ratiometric resistor divider. An example of a simple circuit that would provide a digital interface for the TSP to influence the voltage regulator would be to increase the resistance of Rb by some amount, say 10% and call this value Rb1=1.1*Rb. Then add a second resistor Rb2=11*Rg with an open drain FET called FET2 to ground and the other end connected to VFB such that when FET2 is on, Rb2 is in parallel with Rb1 and Rb1*Rb2/(Rb1+Rb2)=Rb. Then add a third resistor Rb3=9*Rb connected to a FET to ground called FET3, with the other end connected to VFB where Rb3 in parallel with Rb1=0.9*Rb, that is Rb1*Rb3/(Rb1+Rb3)=0.9Rb.

Then normal Vdd is with the Rb2 FET2 ON and Rb3 FET3 OFF. To increase Vdd anticipating a step up in current, turn Rb3 ON. To decrease Vdd anticipating a step down in Idd, turn Rb2 OFF. The TSP has only to drive two GPIO pins to turn on.

To facilitate a prototype of the preemptive mechanism, it is necessary, in one embodiment, to insert a resistor between the ASIC_VDD_SENSE_POS and the VOSEN_L1 input pin on the XDPE1A2G5B voltage regulator. Otherwise, the DAC network would have no possibility of impacting the feedback voltage because it would be working against the extremely low impedance of the sense line. It is important to ensure the stability and response time of the system, so the value needs to be low enough and carefully balanced with the need to apply different polarity and magnitude changes. The resistor ladder that is patterned on the PCB provides flexibility, even if different values are used for the resistors. For example, the use of bipolar GPIO drivers complicates the calculation of the magnitude of the change to Vdd as the nominal Vdd level changes, and the pullup contribution uses a different Vdd voltage and is often difficult to control.

When SP2 is driven low, it pulls down Vdd by 1% at the VR input, causing Vdd to rise by 1% at the chip; when SP3 is driven low, it pulls down Vdd by 2% at the VR input, causing Vdd to rise by 2% at the chip; when SP2 and SP3 are both driven low, they together pull down Vdd by 3% at the VR input, causing Vdd to rise by 3% at the chip; when SP0 is floated, it stops pulling down Vdd by 1% at the VR input, causing Vdd to decrease by 1% at the chip; when SP1 is floated, it stops pulling down Vdd by 2% at the VR input, causing Vdd to decrease by 2% at the chip; when SP0 and SP1 are both floated, they stop pulling down Vdd by 3% at the VR input, causing Vdd to decrease by 3% at the chip.

Of course, other resistance values could be selected to have a different effect. The largest GPIO pin current would be Vdd/50=0.95/50=19 mA which is within range for the example Spartan-7 series FPGA with an output pin current when driving low (IoutLow) that is a maximum of 24 mA in HR I/O banks for standard LVTTL I/O signals.

Features of the described embodiments include the ability to set a new VR target voltage value on any instruction cycle. This provides a fast 20 nS latency to the VR input pin (plus the response time of the VR). Uses the CPS ICU to dispatch the DVS instruction that drives the Digital Vdd value off-chip using 8 GPIO pins. The Min/Max limits are established at compile time and optionally updated at runtime in the program code. In another embodiment, the Min/Max limits set at runtime by the CCU firmware. Input selection and possible scaling control set at runtime in the VR. Min/Max limits may also be set to safety limits at runtime in the VR.

Optional device-dependent scaling table loaded in the secure firmware at runtime. Optional DVS Target Vdd values adjusted by a preload operation just prior to runtime. Parallel 8-bit DAC drives a VR voltage sense input pin.

### Detailed Description—Technology Support

As used herein, the term ‘processor’ signifies a tangible data and information processing machine for use in commerce that physically transforms, transfers, and/or transmits data and information, using at least one process. A processor consists of one or more modules, e.g., a central processing unit (‘CPU’) module; an input/output (′I/O′) module, a memory control module, a network control module, and/or other modules. The term ‘processor’ can also signify one or more processors, or one or more processors with multiple computational cores/CPUs, specialized processors (for example, graphics processors or signal processors), and their combinations. Where two or more processors interact, one or more of the processors can be remotely located relative to the position of the other processors. Where the term ‘processor’ is used in another context, such as a ‘chemical processor’, it will be signified and defined in that context.

The processor can comprise, for example, digital logic circuitry (for example, a binary logic gate), and/or analog circuitry (for example, an operational amplifier). The processor also can use optical signal processing, DNA transformations, quantum operations, microfluidic logic processing, or a combination of technologies, such as an optoelectronic processor. For data and information structured with binary data, any processor that can transform data and information using the AND, OR and NOT logical operations (and their derivatives, such as the NAND, NOR, and XOR operations) also can transform data and information using any function of Boolean logic. A processor such as an analog processor, such as an artificial neural network, also can transform data and information. No scientific evidence exists that any of these technological processors are processing, storing and retrieving data and information, using any process or structure equivalent to the bioelectric structures and processes of the human brain.

The one or more processors also can use a process in a ‘cloud computing’ or ‘time sharing’ environment, where time and resources of multiple remote computers are shared by multiple users or processors communicating with the computers. For example, a group of processors can use at least one process available at a distributed or remote system, these processors using a communications network (e.g., the Internet, or an Ethernet) and using one or more specified network interfaces (‘interface’ defined below) (e.g., an application program interface (‘API’) that signifies functions and data structures to communicate with the remote process).

As used herein, the term ‘computer’ and ‘computer system’ (further defined below) includes at least one processor that, for example, performs operations on data and information such as (but not limited to) the Boolean logical operations using electronic gates that can comprise transistors, with the addition of memory (for example, memory structured with flip-flops using the NOT-AND or NOT-OR operation). Any processor that can perform the logical AND, OR and NOT operations (or their equivalent) is Turing-complete and computationally universal [FACT]. A computer can comprise a simple structure, for example, comprising an I/O module, a CPU module, and a memory that performs, for example, the process of inputting a signal, transforming the signal, and outputting the signal with no human intervention.

As used herein, the term ‘programming language’ signifies a structured grammar for specifying sets of operations and data for use by modules, processors and computers. Programming languages include assembler instructions, instruction-set-architecture instructions, machine instructions, machine dependent instructions, microcode, firmware instructions, state-setting data, or either source code or object code written in any combination of one or more higher level languages, for example, the C programming language and similar general programming languages (such as Fortran, Basic, Javascript, PHP, Python, C++), knowledge programming languages (such as Lisp, Smalltalk, Prolog, or CycL), electronic structure programming languages (such as VHDL, Verilog, SPICE or SystemC), text programming languages (such as SGML, HTML, or XML), or audiovisual programming languages (such as SVG, MathML, X3D/VRML, or MIDI), and any future equivalent programming languages. As used herein, the term ‘source code’ signifies a set of instructions and data specified in text form using a programming language. A large amount of source code for use in enabling any of the claimed inventions is available on the Internet, such as from a source code library such as Github.

As used herein, the term ‘program’ (also referred to as an ‘application program’) signifies one or more processes and data structures that structure a module, processor or computer to be used as a “specific machine” (see In re Alappat, 33 F3d 1526 [CAFC, 1991]). One use of a program is to structure one or more computers, for example, standalone, client or server computers, or one or more modules, or systems of one or more such computers or modules. As used herein, the term ‘computer application’ signifies a program that enables a specific use, for example, to enable text processing operations, or to encrypt a set of data. As used herein, the term ‘firmware’ signifies a type of program that typically structures a processor or a computer, where the firmware is smaller in size than a typical application program, and is typically not very accessible to or modifiable by the user of a computer. Computer programs and firmware are often specified using source code written in a programming language, such as C. Modules, circuits, processors, programs and computers can be specified at multiple levels of abstraction, for example, using the SystemC programming language, and have value as products in commerce as taxable goods under the Uniform Commercial Code (see U.C.C. Article 2, Part 1).

A program is transferred into one or more memories of the computer or computer system from a data and information device or storage system. A computer system typically has a device for reading storage media that is used to transfer the program, and/or has an interface device that receives the program over a network. This transfer is discussed in the General Computer Explanation section.

### Detailed Description—Technology Support

### General Computer Explanation

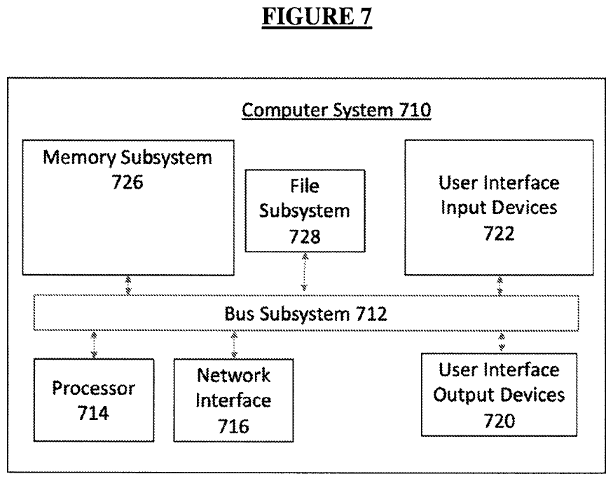

FIG. 7 depicts a computer system suitable for enabling embodiments of the claimed inventions.

In FIG. 7, the structure of computer system 710 typically includes at least one computer 714 which communicates with peripheral devices via bus subsystem 712. Typically, the computer includes a processor (e.g., a microprocessor, graphics processing unit, or digital signal processor), or its electronic processing equivalents, such as an Application Specific Integrated Circuit (‘ASIC’) or Field Programmable Gate Array (‘FPGA’). Typically, peripheral devices include a storage subsystem 724, comprising a memory subsystem 726 and a file storage subsystem 728, user interface input devices 722, user interface output devices 720, and/or a network interface subsystem 716. The input and output devices enable direct and remote user interaction with computer system 710. The computer system enables significant post-process activity using at least one output device and/or the network interface subsystem.

The computer system can be structured as a server, a client, a workstation, a mainframe, a personal computer (PC), a tablet PC, a set-top box (STB), a personal digital assistant (PDA), a cellular telephone, a smartphone, a web appliance, a rack-mounted ‘blade’, a kiosk, a television, a game station, a network router, switch or bridge, or any data processing machine with instructions that specify actions to be taken by that machine. The term ‘server’, as used herein, refers to a computer or processor that typically performs processes for, and sends data and information to, another computer or processor.

A computer system typically is structured, in part, with at least one operating system program, such as Microsoft's Windows, Sun Microsystems's Solaris, Apple Computer's MacOs and iOS, Google's Android, Limix and or Unix. The computer system typically includes a Basic Input/Output System (BIOS) and processor firmware. The operating system, BIOS and firmware are used by the processor to structure and control any subsystems and interfaces connected to the processor. Typical processors that enable these operating systems include: the Pentium, Itanium and Xeon processors from Intel; the Opteron and Athlon processors from Advanced Micro Devices; the Graviton processor from Amazon; the POWER processor from IBM; the SPARC processor from Oracle; and the ARM processor from ARM Holdings.

Any ECIN is limited neither to an electronic digital logic computer structured with programs nor to an electronically programmable device. For example, the claimed inventions can use an optical computer, a quantum computer, an analog computer, or the like. Further, where only a single computer system or a single machine is signified, the use of a singular form of such terms also can signify any structure of computer systems or machines that individually or jointly use processes. Due to the ever-changing nature of computers and networks, the description of computer system 710 depicted in FIG. 7 is intended only as an example. Many other structures of computer system 710 have more or less components than the computer system depicted in FIG. 7.

Network interface subsystem 716 provides an interface to outside networks, including an interface to communication network 718, and is coupled via communication network 718 to corresponding interface devices in other computer systems or machines. Communication network 718 can comprise many interconnected computer systems, machines and physical communication connections (signified by ‘links’). These communication links can be wireline links, optical links, wireless links (e.g., using the WiFi or Bluetooth protocols), or any other physical devices for communication of information. Communication network 718 can be any suitable computer network, for example a wide area network such as the Internet, and/or a local-to-wide area network such as Ethernet. The communication network is wired and/or wireless, and many communication networks use encryption and decryption processes, such as is available with a virtual private network. The communication network uses one or more communications interfaces, which receive data from, and transmit data to, other systems. Embodiments of communications interfaces typically include an Ethernet card, a modem (e.g., telephone, satellite, cable, or ISDN), (asynchronous) digital subscriber line (DSL) unit, Firewire interface, USB interface, and the like. Communication algorithms (‘protocols’) can be specified using one or communication languages, such as HTTP, TCP/IP, RTP/RTSP, IPX and/or UDP.

User interface input devices 722 can include an alphanumeric keyboard, a keypad, pointing devices such as a mouse, trackball, toggle switch, touchpad, stylus, a graphics tablet, an optical scanner such as a bar code reader, touchscreen electronics for a display device, audio input devices such as voice recognition systems or microphones, eye-gaze recognition, brainwave pattern recognition, optical character recognition systems, and other types of input devices. Such devices are connected by wire or wirelessly to a computer system. Typically, the term ‘input device’ signifies all possible types of devices and processes to transfer data and information into computer system 710 or onto communication network 718. User interface input devices typically enable a user to select objects, icons, text and the like that appear on some types of user interface output devices, for example, a display subsystem.

User interface output devices 720 can include a display subsystem, a printer, a fax machine, or a non-visual communication device such as audio and haptic devices. The display subsystem can include a cathode ray tube (CRT), a flat-panel device such as a liquid crystal display (LCD), an image projection device, or some other device for creating visible stimuli such as a virtual reality system. The display subsystem also can provide non-visual stimuli such as via audio output, aroma generation, or tactile/haptic output (e.g., vibrations and forces) devices. Typically, the term ‘output device’ signifies all possible types of devices and processes to transfer data and information out of computer system 710 to the user or to another machine or computer system. Such devices are connected by wire or wirelessly to a computer system. Note: some devices transfer data and information both into and out of the computer, for example, haptic devices that generate vibrations and forces on the hand of a user while also incorporating sensors to measure the location and movement of the hand. Technical applications of the sciences of ergonomics and semiotics are used to improve the efficiency of user interactions with any processes and computers disclosed herein, such as any interactions with regards to the design and manufacture of circuits, that use any of the above input or output devices.

Memory subsystem 726 typically includes a number of memories including a main random-access memory (‘RAM’) 730 (or other volatile storage device) for storage of instructions and data during program execution and a read only memory (‘ROM’) 732 in which fixed instructions are stored. File storage subsystem 728 provides persistent storage for program and data files, and can include a hard disk drive, a floppy disk drive along with associated removable media, a CD-ROM drive, an optical drive, a flash memory such as a USB drive, or removable media cartridges. If computer system 710 includes an input device that performs optical character recognition, then text and symbols printed on paper can be used as a device for storage of program and data files. The databases and modules used by some embodiments can be stored by file storage subsystem 728.

Bus subsystem 712 provides a device for transmitting data and information between the various components and subsystems of computer system 710. Although bus subsystem 712 is depicted as a single bus, alternative embodiments of the bus subsystem can use multiple busses. For example, a main memory using RAM can communicate directly with file storage systems using Direct Memory Access (‘DMA’) systems.

### Detailed Description—Conclusion

The Detailed Description signifies in isolation the individual features, structures, functions, or characteristics described herein and any combination of two or more such features, structures, functions or characteristics, to the extent that such features, structures, functions or characteristics or combinations thereof are enabled by the Detailed Description as a whole in light of the knowledge and understanding of a skilled person, irrespective of whether such features, structures, functions or characteristics, or combinations thereof, solve any problems disclosed herein, and without limitation to the scope of the Claims of the patent. When an ECIN comprises a particular feature, structure, function or characteristic, it is within the knowledge and understanding of a skilled person to use such feature, structure, function, or characteristic in connection with another ECIN whether or not explicitly described, for example, as a substitute for another feature, structure, function or characteristic.

In view of the Detailed Description, a skilled person will understand that many variations of any ECIN can be enabled, such as function and structure of elements, described herein while being as useful as the ECIN. One or more elements of an ECIN can be substituted for one or more elements in another ECIN, as will be understood by a skilled person. Writings about any ECIN signify its use in commerce, thereby enabling other skilled people to similarly use this ECIN in commerce.

This Detailed Description is fitly written to provide knowledge and understanding. It is neither exhaustive nor limiting of the precise structures described, but is to be accorded the widest scope consistent with the disclosed principles and features. Without limitation, any and all equivalents described, signified or Incorporated By Reference (or explicitly incorporated) in this patent application are specifically incorporated into the Detailed Description. In addition, any and all variations described, signified or incorporated with respect to any one ECIN also can be included with any other ECIN. Any such variations include both currently known variations as well as future variations, for example any element used for enablement includes a future equivalent element that provides the same function, regardless of the structure of the future equivalent element.

It is intended that the domain of the set of claimed inventions and their embodiments be defined and judged by the following Claims and their equivalents. The Detailed Description includes the following Claims, with each Claim standing on its own as a separate claimed invention. Any ECIN can have more structure and features than are explicitly specified in the Claims.

What is claimed is:

1. A system for providing programmatic control of a processor power load comprising a processor, a circuit for synthesizing a clock period and a compiler for inserting a plurality of “No Operation” (NOP) instructions into a computer program having a plurality of algorithms, wherein the NOP instructions enable more efficient power management while the processor is executing the plurality of algorithms.

2. The system of claim 1, wherein the compiler inserts NOP instructions into the computer program instructions to lengthen a time period for at least one power-intensive algorithm of the computer program to be executed wherein a maximum power load is reduced during execution of the at least one power-intensive algorithm.

3. A system for providing programmatic control of a processor power load comprising a processor, a circuit for synthesizing a clock period and a compiler for generating a computer program having a plurality of algorithms, wherein the compiler inserts power control instructions in the computer program to enable more efficient power management while the processor is executing the plurality of algorithms.

4. The system of claim 3, wherein the circuit for synthesizing the clock period changes the clock period to minimize power during execution of at least one of the plurality of algorithms.

5. The system of claim 3, wherein the compiler provides an instruction to the processor to change the clock period to minimize power during execution of at least one of the plurality of algorithms.

6. The system of claim 3, wherein the circuit for synthesizing the clock period changes the clock period to minimize a time of execution of at least one of the plurality of algorithms.

7. The system of claim 3, wherein the compiler provides an instruction to the processor to control the circuit for synthesizing the clock period to minimize power.

8. The system of claim 3, wherein the compiler provides an instruction to the processor, during execution, wherein an upcoming power problem is anticipated.

9. A method for enabling an operating voltage and an operating frequency of a processor to be dynamically modified during execution of a program comprising deterministically initiating a change to the operating voltage under processor control.

10. The method of claim 9, further comprising deterministically initiating a change to the operating frequency under processor control.

11. The method of claim 10 further comprising:
selecting an initial operating voltage of the processor before booting the processor; and
changing the operating voltage to a second operating voltage for a portion of the program in response to an instruction in the program.

12. The method of claim 11, further comprising:
selecting an initial operating frequency of the processor before booting the processor;
changing the operating frequency to a second operating frequency for a portion of the program in response to an instruction in the program.

13. The method of claim 12, wherein the program is partitioned into multiple segments, wherein between segments the program is halted, the operating voltage and the operating frequency are changed under processor control and stabilized, and the program restarted, wherein the dynamic control maximizes performance of the processor in a given power envelope.

14. The method of claim 10, wherein the program is partitioned into multiple segments, where between segments the program is halted, the operating voltage is changed and stabilized; and the program restarted wherein the dynamic control maximizes performance of the processor in a given power envelope to mitigate runtime di/dt events.

15. The method of claim 14, wherein a compiler provides an instruction that is executed by the processor between segments of the program.
